(19) United States
(12) Patent Application Publication
(10) Pub. No.: US 2019/0188656 A1
(43) Pub. Date: Jun. 20, 2019

(54) SYSTEM AND METHOD FOR EXCHANGING ITEMS

(71) Applicant: Working Dog Ventures Ltd., Vancouver (CA)

(72) Inventor: Richard JAMES, Vancouver (CA)

(21) Appl. No.: 16/222,723

(22) Filed: Dec. 17, 2018

Related U.S. Application Data
(60) Provisional application No. 62/599,900, filed on Dec. 18, 2017.

(51) Int. Cl. G06Q 20/06; G06Q 30/06

(52) U.S. Cl. CPC G06Q 20/065; G06Q 50/01; G06Q 30/0635

(57) ABSTRACT

The present disclosure describes a cloud-based software platform with a corresponding mobile application or app executing on a mobile device that enables an online exchange environment where users conveniently swap goods such as clothing. The app allows users to swap or trade clothing using an in-app virtual currency that may be accrued by participating on online exchange of goods through the app. Sellers list their items with along with one or more photographs of the item and a target price denominated in diamonds into a searchable data store. Buyers can search the database and purchase items using their accrued in-app virtual currency.

### CROSS-REFERENCE TO RELATED APPLICATIONS

This application claims the benefit of U.S. provisional patent application No. 62/599,900 filed on Dec. 18, 2017.

### TECHNICAL FIELD

The present disclosure relates to an electronic system for exchanging items thereon. The present disclosure also relates to a method of exchanging items on an electronic system.

### BACKGROUND

Electronic commerce systems (e.g. online marketplaces) for trading and exchanging goods and services have become increasingly popular over the past decade. While the desired goals of these electronic commerce systems are generally the same or similar (i.e. a good or service is exchanged thereon), the mechanics of how such goods and services are exchanged in or over the systems may vary.

For example, United States issued U.S. Pat. No. 8,352,328 discloses a method for searching goods on an electronic marketplace, the method comprising: (i) receiving, at a first computer, search parameters to facilitate the search for the good; (ii) communicating the search parameters to a second computer having a database of data records corresponding with goods offered for sale via the electronic marketplace; (iii) receiving, from the second computer, search results from the database of data records of the second computer, the search results satisfying the search parameters; (iv) receiving from the second computer a network address associated with yet another computer participating in the electronic marketplace; and (v) displaying the search results.

For example, United States issued U.S. Pat. No. 7,080,070 discloses a system comprising: (i) a database containing an electronic catalog of items; and (ii) a server that provides interface for browsing the electronic catalog over a computer network, the user interface including functionality for users to at least formulate and submit search queries for searching the electronic catalog, assign category names to individual search queries, and save the search queries and associated category names on the server system for subsequent use as user-defined categories that are selectable via the user interface to browse the electronic catalog of items.

Since the global financial crisis in 2008-2009, at least a portion of the consumer market has turned to a “sharing economy” in an effort to economize on their spending habits and lifestyle. Such sharing economies provide economical consumers with access to fashion variety and a channel to exchange or trade commodities. Such sharing economies, as a result, also prolong the “lifespan” of such exchanged/traded commodities. Presently, sharing economies remain highly desirable and in demand. Such desire and demand is at least in part fueled by the continued demand for frugality among consumers (for example, among the millennial population).

In an increasingly digital environment, electronic commerce system developers are constantly evaluating ways to improve the consumer experience and the transfer of goods and services across such electronic commerce systems. Non-limiting examples of areas of improvement include greater convenience, increased trust between buyer and seller, increased user-ship of electronic commerce systems.

### SUMMARY

As described in a part of this disclosure, in accordance with an aspect of the present invention there is provided a method of providing an electronic exchange for a plurality of items. The method includes, at a server: maintaining information corresponding to each of the plurality of items, and an account for each user of the exchange; receiving a purchase request from a purchaser for a selected one of the plurality of items through an electronic device in communication with the server, the request comprising a purchaser identifier and an item identifier for the selected item; obtaining, for the selected item, the corresponding information comprising at least an image of the item, a seller of the item, and a price associated with the item, the price denominated in a virtual currency usable only within the electronic exchange; verifying that an account of the purchaser has an amount at least equal to the price; and completing purchase of the selected item by crediting an account of the seller and debiting the account of the purchaser by the price.

In accordance with another aspect of the present invention there is provided a system for exchanging a plurality of items using a virtual currency. The system includes: a server and an electronic device. The server includes: a first processor; first memory interconnected with the first processor; an input interface in communication with the first processor; a display in communication with the first processor; a first network interface in communication with the processor; and a first computer readable medium in communication with the processor, the first computer readable medium adapted for storing processor executable instructions that, when executed on the first processor: maintain information corresponding to each of the plurality of items; receive a purchase request from a purchaser for a selected one of the plurality of items, the request comprising a purchaser identifier and an item identifier for the selected item; obtain for the selected item, the corresponding information comprising at least an image of the item, a seller of the item, and a price associated with the item, the price denominated in a virtual currency usable only within the electronic exchange; verify that the purchaser has an account in the system having an amount at least equal to the price; complete purchase of the selected item by crediting an account of the seller and debiting the account of the purchaser by the amount denominated in the virtual currency. The electronic device in communication with the server, includes a second processor; a second memory interconnected with the second processor; a second network interface in communication with the second processor; and a second computer readable medium in communication with the second processor, the second computer readable medium adapted for storing processor executable instructions that, when executed cause the second processor to: send the purchase request from for the selected item.

In accordance with yet another aspect of the present invention, there is provided an electronic device that includes a processor; a memory interconnected with the processor; a network interface in communication with the processor; and a computer readable medium in communication with the processor. The computer readable medium is adapted for storing processor executable instructions that, when executed cause the processor to: send a purchase request from a user for a selected one of the plurality of items. The request includes a user identifier and an item identifier for the selected item to a server, wherein the server maintains information corresponding to each of the items; receives the purchase request; obtains for the selected item, the corresponding information comprising at least an image of the item, a seller of the item, and a price associated with the item, the price denominated in a virtual currency; verifies that the user has an account having an amount at least equal to the price; and completes purchase of the selected item by crediting an account of the seller and debiting the account of the user by the amount denominated in the virtual currency.

The item may be a wardrobe item.

Real currency may be exchanged for virtual currency.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF DRAWINGS

In the accompanying figures, which illustrate by way of example only, one or more embodiments of the present invention:

FIG. 1 is a schematic system block diagram of an electronic system for exchanging items according to a first embodiment of the present invention;

FIG. 2 is a simplified block diagram of hardware components of server computing devices used in FIG. 1;

FIG. 3 is a simplified block diagram of hardware components of a device used in FIG. 1;

FIG. 4 is a flowchart illustrating example procedural steps taken by a device operating within the system of FIG. 1, the device running a mobile application or an app;

FIG. 5 is an extension of the flowchart of FIG. 4 depicting example process steps executed upon a main page being selected by a user of the system of FIG. 1;

FIG. 6 is an extension of the flowchart of FIG. 4 depicting example process steps executed upon a search selection by a user of the system of FIG. 1;

FIG. 7 is an extension of the flowchart of FIG. 4 depicting example process steps executed upon a messages page being selected by a user of the system of FIG. 1;

FIG. 8 is an extension of the flowchart of FIG. 4 depicting example process steps executed upon a user profile page being selected by a user of the system of FIG. 1;

FIG. 9 is an extension of the flowchart of FIG. 4 depicting example process steps executed by a user of the system of FIG. 1, the process steps related to an in-system virtual currency;

FIGS. 10a-10p are schematic illustrations of examples of user interface pages of the app related to the startup procedure and other activities;

FIGS. 11a-11o are schematic illustrations of examples of pages interface pages of the app related to profile editing and other activities.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

In this disclosure, the term “app” means a customized software application. Those knowledgeable in the art will appreciate that embodiments of the present invention lend themselves well to practice in the form of computer program products. Accordingly, it will be appreciated that embodiments of the present invention may comprise computer program products comprising computer executable instructions stored on a non-transitory computer readable medium that, when executed, cause a computer to undertake methods according to the present invention, or a computer configured to carry out such methods. The executable instructions may comprise computer program language instructions that have been compiled into a machine-readable format. The non-transitory computer-readable medium may comprise, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

The present disclosure relates to an electronic system for exchanging items thereon. The present disclosure also relates to a method of exchanging items on an electronic system. There are many difficulties associated with establishing a system that provides an easy-to-use interface for exchanging or responsibly donating goods. Using clothing as a non-limiting example of a good, it has been estimated that people consistently wear only about ⅕ of their wardrobe about ⅘ of the time. The remaining ⅘ of their wardrobe is often unused, not often used, or not used at all. In addition, responsibly removing unwanted clothing (e.g. by not simply discarding clothing items into the trash) is difficult.

Establishing an electronic commerce system that allows users to acquire or exchange high-quality goods easily, safely, and efficiently also is not straightforward. For example, it may be challenging to encourage users of the electronic commerce system to only make available for exchange high quality items, or to induce users to post polished photographs that convey the quality of the item being offered for exchange on the electronic commerce system. In addition, consumers are often reluctant buy items (e.g. clothing items) that they have not seen beforehand. Furthermore, shipping and handling fees associated with the transfer of purchased goods may be expensive, particularly for specialty items. Moreover, creating a sustainable resale market is challenging because such markets require a high level of vendor/consumer participation in order to be profitable.

High level vendor/consumer participation in a resale market is often hindered both by the ability to attract and retain potential vendors and consumers. A way to increase attraction and retention of vendors and consumers is to create an easy-to-use (i.e. user friendly) electronic commerce system. Furthermore, a sizable inventory is often needed, and a technically and technologically efficient system comprising hardware and software components is required to at least take the hassle and mistrust out of selling and exchange items through the electronic system (e.g. Internet). Such ease-of-use considerations involve multiple factors including, but not limited to, ensuring quality and consistency of images or photographs of items exchanged, presenting digital content in an engaging manner, providing a secure payment system, having robust return or refund policies, having reliable shipping, and establishing trust between swappers or buyers and sellers.

Differentiation and innovation, including technological innovation in the overall design of the electronic commerce system, may assist in alleviating some of the social and technological problems currently present in electronic commerce systems. The results of such innovation and differentiation may lead to a enhanced customer experience (both from the buyer and seller perspective), higher customer retention (i.e. higher retention of both sellers and buyers or swappers), and an opening of new markets.

The present disclosure relates, at least in part, to a system for exchanging items thereon. The system can be an electronic exchange platform that communicates with a corresponding mobile application executing on a mobile device. The system can be cloud-based. Examples of goods that may be exchanged on the system include, but are not limited to, new or used clothing items, jewelry, jewelry accessories, and footwear. Items may be exchanged on the system using a virtual currency unique to the system. For example, a seller may list: (i) certain items for sale/exchange; (ii) one or more photographs of the certain items; and (iii) a desired price denominated in units of the virtual currency; into a searchable database. In turn, potential purchasers may search the searchable database and purchase the certain items using the virtual currency available in their user accounts. A user (e.g. a seller or a purchaser) may obtain in-system virtual currency by performing acts including, but not limited to, selling items on the platform, participating in special promotions, and marketing the app to their social network. Generally, the system comprises one or more computing devices that are used collectively to make up a server. The server is interconnected through a network (for example, a wireless network) to an electronic device (for example, a mobile handheld device) that executes an app. The electronic device, through the app, communicates with the server for the purposes of performing an exchange or trade of a good.

### System Architecture

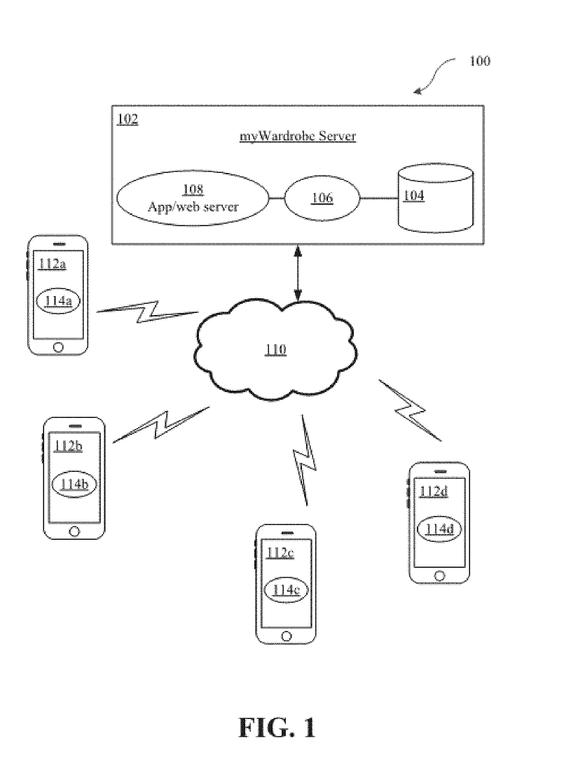

Referring to FIG. 1, and according to a first embodiment of an electronic commerce system described herein, there is depicted a simplified block diagram of a system 100. As depicted in FIG. 1, the system 100 includes a server side computing system 102 in data communication with electronic devices 112a to 112d (individually and collectively, “devices 112”) via a network 110. Server side computing system 102 comprises a database 104, a web-server software 108, and an application logic 106 therebetween and adapted for facilitating communication between the database 104 and the web-server software 108.

As contemplated in this first embodiment, server side computing system 102 is a server. The server 102 includes a web-server software 108 running thereon, the web-server software 108 adapted for communicating with an app 114 running on a device 112. The web-server software 108 can be any suitable web-server software that is adapted to permit apps and mobile browser software (e.g., Chrome™, Internet Explorer™, Mozilla Firefox™, Safari™) running on devices 112 to access data on server 102 through network 110. Suitable web-server software includes, but is not limited to, the Apache HTTP Server, the Internet Information Server (IIS). In other embodiments, the server side computing system can be a system comprising a network of computers (e.g. database server computer, application logic server computer, web-server computer), or a cloud service that uses a large network of server computers (e.g. database server computers, application logic server computers, web-server computers), the server computers collectively hosting multiple instances of application logic server software, database software, and web-server software. In other embodiments, the system does not include a web-server software running on a server that communicates to an app running on devices 112.

Server 102 is accessed by devices 112 that each run a mobile application (e.g. app 114), or mobile browser software, via the Hypertext Transfer Protocol (HTTP) or its secure version (HTTPS) for data entry, image uploading, data editing, report generation, account configuration, changing settings, buying, selling, sending and receiving messages and various other activities enabled by the electronic commerce platform as will be described later. In other embodiments, the server is not accessed via HTTP or HTTPS, but instead is accessed via another suitable protocol.

Application logic 106 executing on server 102 implements application logic rules for system 100. As contemplated in this first embodiment, application logic 106 can be implemented as software components, services, server software, or other software components forming part of application logic 106. Application logic 106 encodes specific business rules determining the creation, manipulation, alteration, generation, or verification of data using data received from devices 112 or retrieved from database 104.

Database 104 provides storage for persistent data. Persistent data includes, but is not limited to, data pertaining to user records, items made available for purchase, exchange or swapping, in-system virtual currency accounts, user credit card and address information. As is known in the art, persistent data is often required for applications that reuse saved data across multiple sessions or invocations. As contemplated in this first embodiment, database 104 is supported by a relational database management software (RDBMS), and is encrypted. Suitable RDBMS include, but are not limited to, the Oracle server, the Microsoft SQL Server database, the DB2 server, MySQL server, and any alternative type of database such as an object-oriented database server software. Encryption can be done by any method known in the art. Suitable encryption methods or algorithms include, but are not limited to, RSA public-key encryption, Advanced Encryption Standard (AES), Triple Data Encryption Algorithm (3DES), and Blowfish. In other embodiments, the database on the server side computing system is not an RDBMS. In other embodiments, the database is not encrypted.

In other embodiments, server 102 has a separate database server hardware to host database 104 software. In other embodiments, the system has a separate application server computer for the purpose of providing additional resources in terms of CPU, memory capacity, and storage capacity in order to improve the performance of the system. In other embodiments, the system further comprises a business logic server that is external to server 102, the business logic server for hosting an application logic (e.g. application logic 106). Other computing devices suitable for communication with server 102 or as devices 112 include, but are not limited to, server class computers, workstations, personal computers, and any other suitable computing device.

As contemplated in this first embodiment, network 110 is the Internet. In other embodiments, the network can be any other suitable network including, but not limited to, a cellular data network, W-Fi™, Bluetooth™, WMax™, IEEE 802.16 (WirelessMAN), and any suitable alternative thereof. The suitable data communications interface contemplated in this embodiment between devices 112 and network 110 is wireless. The interface can be an antenna, a Bluetooth™ transceiver, a Wi-Fi™ adapter, or a combination thereof.

As contemplated in this first embodiment, devices 112 are handheld electronic devices. Non-limiting examples of handheld electronic devices include personal digital assistant (PDA), cellular telephone, smartphone (e.g. iPhone™, Blackberry™, Windows™ Phone), media player (e.g. iPod™), and a device which combines one or more aspects or functions of the foregoing devices. In other embodiments, the devices can be any other suitable electronic devices having a suitable data communications interface to network 110. Devices 112 may be used by the users of system 100 to participate in activities facilitated by the system 100 including, but not limited to, an swapping or in-system purchase of clothing items. Each device 112 is equipped with an app 114 (shown as apps 114a to 114d in FIG. 1). As contemplated in this first embodiment, apps 114 communicate with server software 108 via network 110.

### Server Hardware

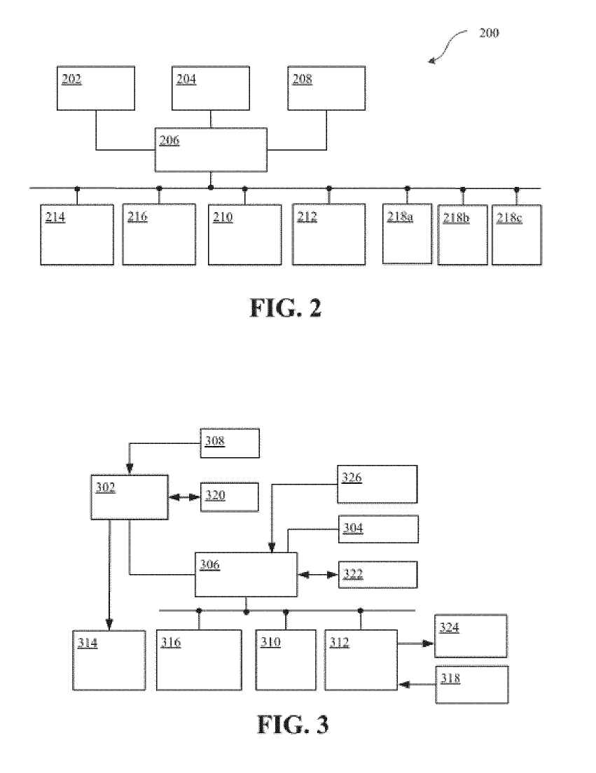

Referring to FIG. 2, and according to an embodiment of server 102, there is depicted a simplified block diagram of computing device hardware 200. Hardware 200 comprises a processor 202 such as, but not limited to, a microprocessor, a memory medium 204, and interface circuit 206 adapted to provide a means of communication between processor 202 and memory medium 204. Interface circuit 206 also interconnects input and output (I/O) components such a display 214, a network adapter 216, and a storage medium 210. Interface circuit 206 also interconnects a printer 212 and one or more additional peripherals 218a to 218c (individually and collectively, peripherals 218). Suitable peripherals 218 include, but are not limited to a keyboard, a camera, a scanner, a touch panel, a joystick, an electronic mouse, touch screen, track-pad, and other input or pointing devices, and any combination thereof. In other embodiments, the interface circuit does not interconnect a printer. In other embodiments, the interface circuit does not interconnect any peripherals.

Memory medium 204 may be in the form of volatile memory or a combination of volatile and non-volatile memory, including, but not limited to, dynamic or static random access memory (RAM), read-only memory (ROM), flash memory, solid state memory and the like.

Interface circuit 206 includes a system bus for coupling any of the various computer components 210, 212, 214, 216, 218 to the processor 202. Suitable interface circuits include, but are not limited to, Industry Standard Architecture (ISA), Micro Channel Architecture (MCA), Extended Industry Standard Architecture (EISA), VESA Local Bus (VLB), Peripheral Component Interconnect (PCI), Peripheral Component Interconnect Extended (PCI-X), Accelerated Graphics Port (AGP), Peripheral Component Interconnect Express (PCIe).

Storage medium 210 can be any suitable storage medium including, but not limited to, a hard disk drive (HDD), a solid state drive (SSD), EEPROM, CD-ROM, DVD, and any other suitable data storage element or medium. Storage medium 210 is readable by processor 202.

Display 214 can be any suitable display including, but not limited to, a touch screen.

Network adapter 216 in server 102 facilitates wired or wireless connections to an Ethernet, W-Fi™, Bluetooth™, cellular network or other suitable network, thereby enabling connection to shared or remote drives, one or more networked computer resources, other networked devices, I/O peripherals and the like. Devices 112 also contain complementary network adapters therein for connecting with a suitable network, and are further equipped with browser or other thin-client or rich-client software. As contemplated in this embodiment, network adapter 216 comprises a wireless network interface card that allows communication with other computers through a data network such as network 110. In other embodiments, the network adapter does not comprise a wireless network interface card. In other embodiments, the network adapter communicates with the network via a wired connection.

### Device Hardware

Referring to FIG. 3, and according to an embodiment of a device, there is depicted a simplified block diagram of device 112. Device 112 comprises a processor 302 such as, but not limited to, a microprocessor, a memory medium 304, a touch input 308, a battery 320, and a display 314. Components 302 and 304 communicate with each other through an interface circuit 306. Interface circuit 306 also interconnects components including, but not limited to, a wireless network interface 316, a storage medium 310, an input-output (I/O) interface 322, a camera 326 and an audio codec 312. Audio codec 312 in turn connects to one of more microphones 318 and one or more speakers 324.

Wireless network interface 316 includes one or more of a wireless LAN transceiver (e.g. W-Fi™ transceiver), an infrared transceiver, a Bluetooth™ transceiver, and a cellular telephony transceiver. I/O interface 322 may include one or more wired power and communication interfaces such as a USB port.

Input 308 may be a keypad or keyboard, a touch panel, a multi-touch panel, a touch display or multi touch display having a software keyboard or keypad displayed thereon.

myWardrobe™ App

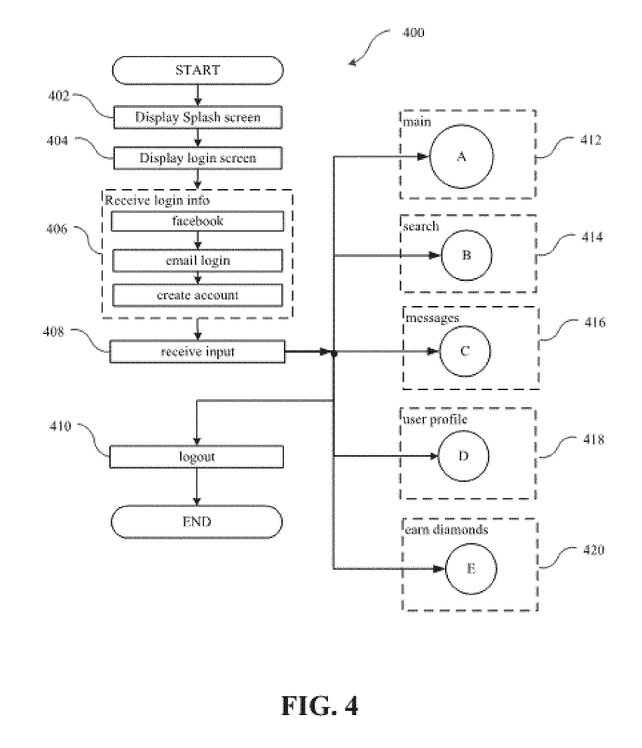

Referring to FIGS. 4 to 11, and according to an embodiment of an app contemplated herein, there is depicted a flowchart 400 describing process steps followed by an app 114.

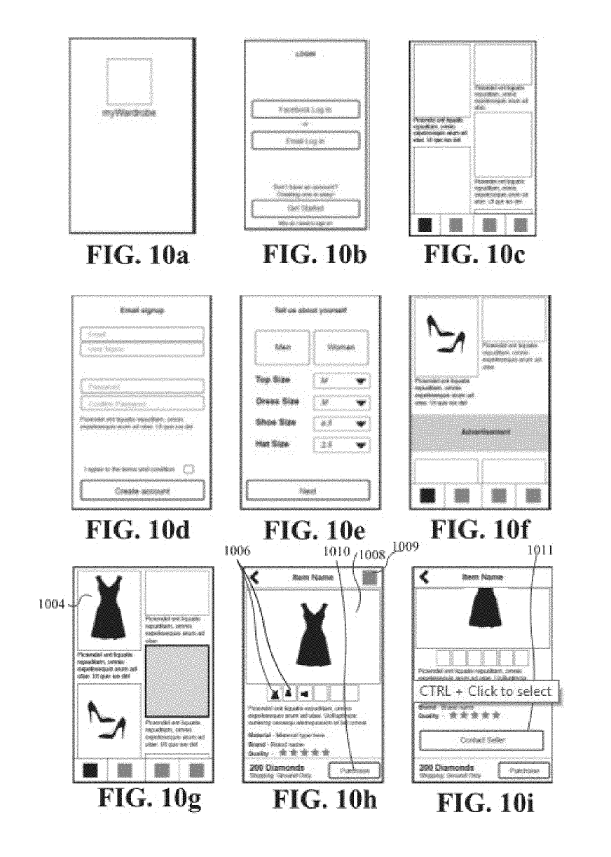

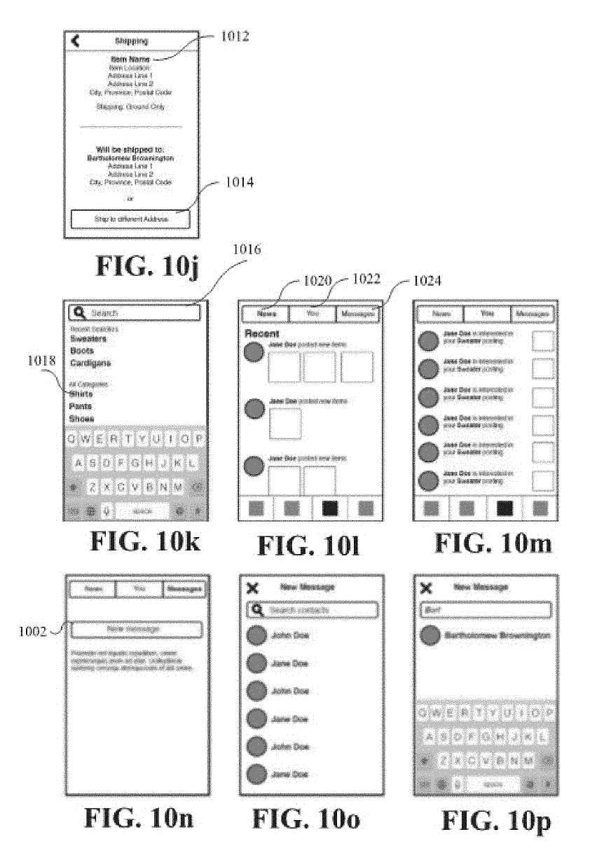

As contemplated in this embodiment of the app, app 114 displays a splash screen (step 402) that is followed by a login screen (step 404). An example of a splash screen display page is provided at FIG. 10a. The app 114 receives data representing login information or login process (step 406). An example of a login page is depicted in FIG. 10b. For returning users, users enter their user login information to gain access to the contents of app 114. The login process can be federated with a third-party social media site or email service (e.g. Facebook™ Gmail™, Instagram™) as illustrated in FIG. 10b. New users are able to select an option of creating a new user account. An example of a login creation screen is provided at FIG. 10d. For new users selecting the option to create a new user account, the new user is guided through a series of app pages adapted to facilitate the new user account set-up process. Examples of app pages include those depicted in FIG. 10c and FIG. 10d. After creating a new account, the user provides additional information such as whether the user is a man or a woman, top size, dress size, shoe size and hat size, as illustrated in FIG. 10e. Images of the selected items are then displayed (e.g. FIGS. 10f and 10g).

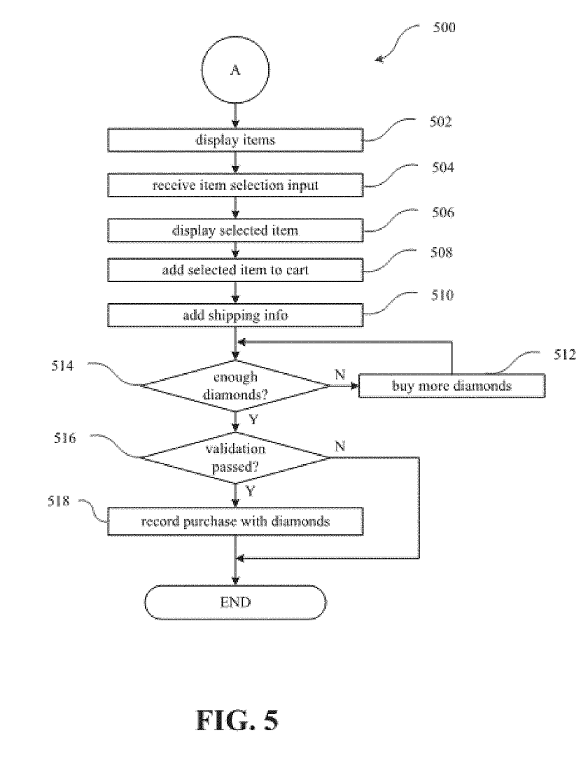

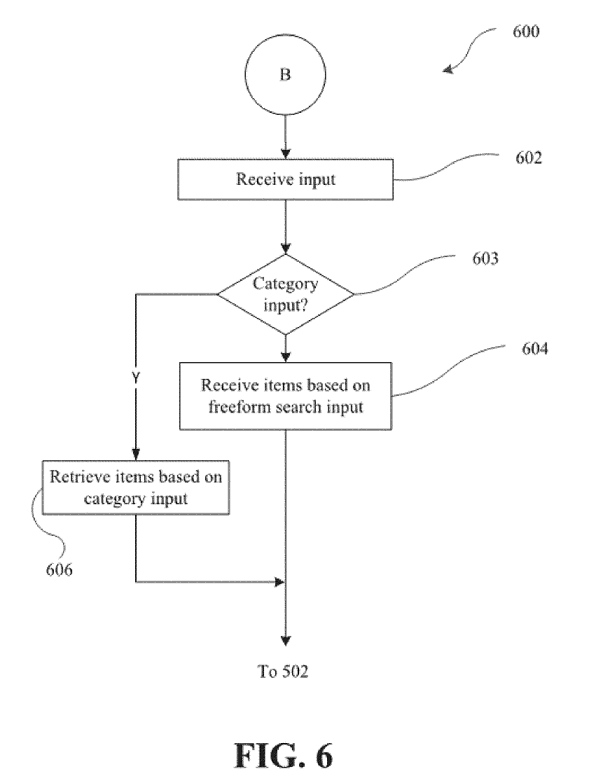

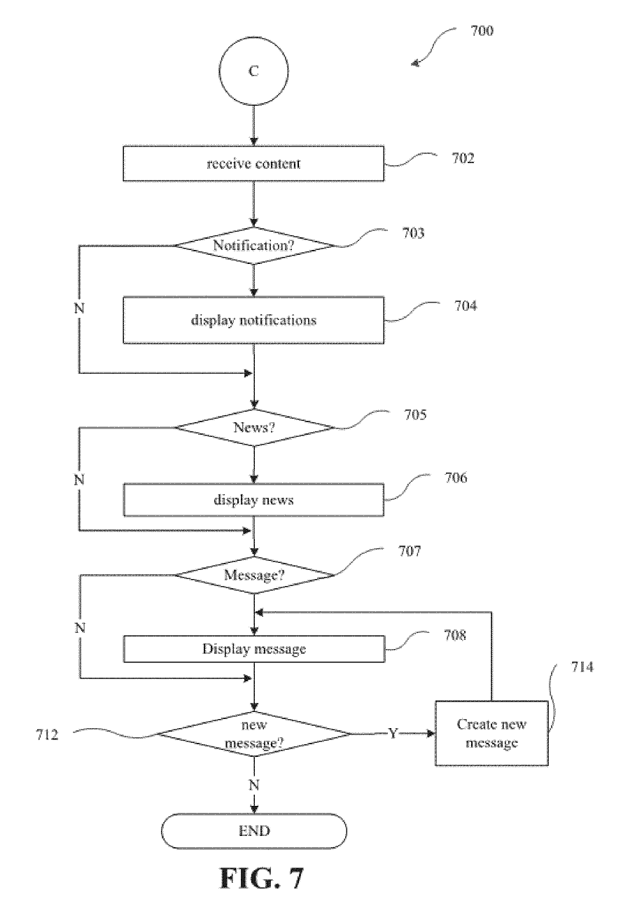

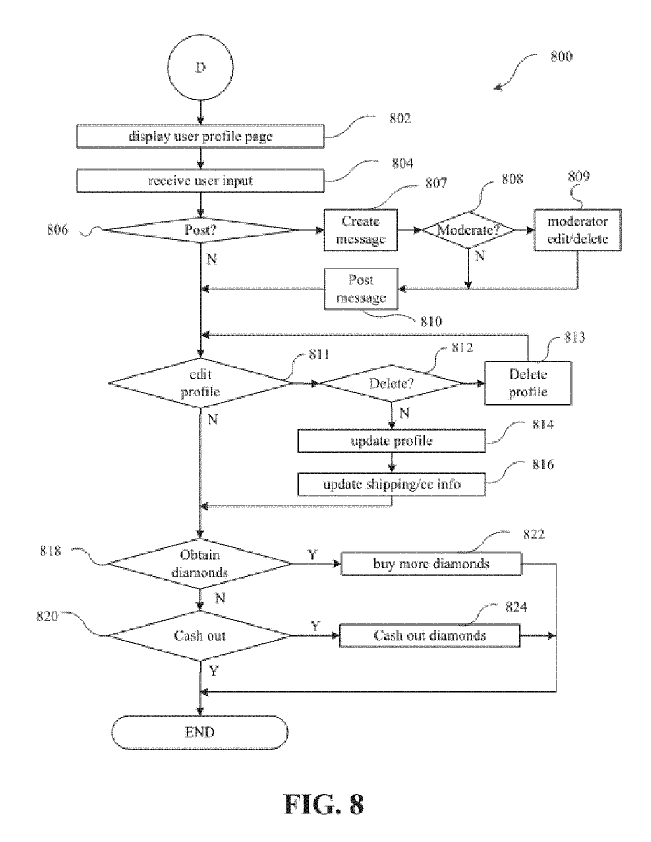

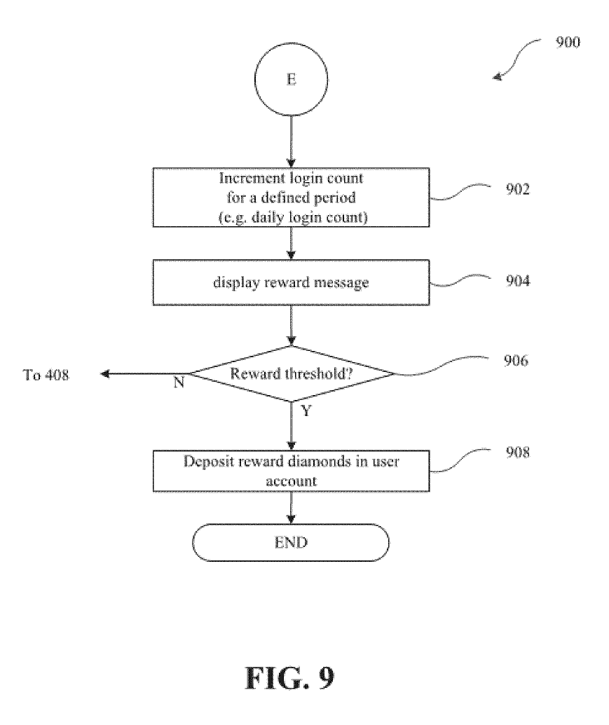

App 114 receives user input that may lead to one of several sequences of pages and their corresponding processes (step 408). As depicted in FIG. 4, the user may select to go to one of: a main screen (step 412), a search page (step 414), a messages page or pane (step 416), a user profile page (step 418), or a page pertaining to the user's accumulated in-system virtual currency (e.g. “earn diamonds”) page (step 420). Steps 412, 414, 416, 418 and 420 lead to a continuation of the flowchart 400 as indicated by the flowchart continuity links denoted A, B, C, D and E, and illustrated in FIG. 5, FIG. 6, FIG. 7, FIG. 8 and FIG. 9 respectively.

If step 412 is selected by a user (i.e. “A” in FIG. 4), then process 500 illustrated in FIG. 5 is carried out. Device 112 executing app 114 displays a page illustrating items for selection (step 502) as depicted in FIG. 10g. App 114 receives an item selection input (step 504), for example on image window 1004, and then displays the selected item (step 506) as illustrated in FIG. 10h. One or more smaller clickable buttons 1006 that display small scale, different images the selected item. When one of these buttons 1006 is clicked, then a corresponding enlarged image is displayed in image window 1008. The user may indicate liking the item by clicking on toggle button 1009. FIG. 10i depicts the same page as shown in FIG. 10h with the page scrolled up to reveal a button 1011 to contact or follow the seller. A non-limiting example of a selected item is an item of clothing. If the selected item is desired, then the selected item is added to a shopping cart (step 508) by clicking on the purchase button 1010. A name or description of the selected item, and the address of the user is then displayed in FIG. 10j in a text label 1012. If the user wishes to use a different address than the address in his or her profile, then the user clicks button 1014. A different shipping information is then inputted by the user into app 114 (step 510). If the user does not have a required amount of in-system virtual currency (e.g. “diamonds”) (step 514), then app 114 proceeds to allow the user to acquire more in-system virtual currency (step 512). If the user has a required amount of in-system virtual currency, and other validation criteria (e.g. accurate shipping address, user verification information) is met (step 516), then app 114 records the purchase transaction (step 518) and finalizes the purchase transaction.

If step 414 is selected (i.e. “B” in FIG. 4), then process 600 illustrated in FIG. 6 is carried out. Device 112 executing app 114 receives an input (step 602) from the user that corresponds to either to a freeform search input entered in edit control 1016 or to a category filter input received on one of the category labels 1018 as illustrated in FIG. 10k. An example of a search input may be a search text such as “sweater” or “boot” or another freeform text for a particular wardrobe item as illustrated in FIG. 10k. If the received input is a category input (step 603) then the app 114 retrieves items based on the category filter input (step 606). However, if app 114 receives freeform search input (step 603) in relation to the items to be listed, then app 114 lists items that match the freeform text (step 604). The category filter input allows a user to look for items in a specific category only. A user may be interested only in shirts, or only in pants, or only in shoes as illustrated in FIG. 10k. For example, if the user is only interested in shoes, then the app filters out wardrobe items do not match shoes and only depicts shoes. App 114 retrieves (step 606) and then displays results (step 502) based on category filter inputs. In other embodiments, the app does not receive a filter input.

If step 416 is selected by a user (i.e. “C” in FIG. 4), then process 700 illustrated in FIG. 7 is carried out. Device 112 executing app 114 receives content (step 702). Content may include items like news, notifications or messages. App 114 then displays notifications, if any (steps 703, 704) upon the user pressing a notification button 1022. An example notification can be whether the user has indicated that he or she liked a particular item using app 114. In some embodiments, the app further displays news, if any (steps 705, 706). An example set of news items (1020) is displayed in FIG. 10l. The app 114 may further display messages (step 708) upon the user pressing a messages button 1024. If the user wishes to create a new message (step 712) then a new message is created (step 714) upon clicking the new message button 1002 (as illustrated in FIG. 10n), selecting a recipient (for example, as illustrated in FIG. 100 and FIG. 10p) and then displayed (steps 707, 708). Otherwise process 700 terminates. An example set of messages is illustrated in FIG. 10m. Messages displayed when the messages button 1024 is pressed, thus can indicate whether others liked a particular posting by the user.

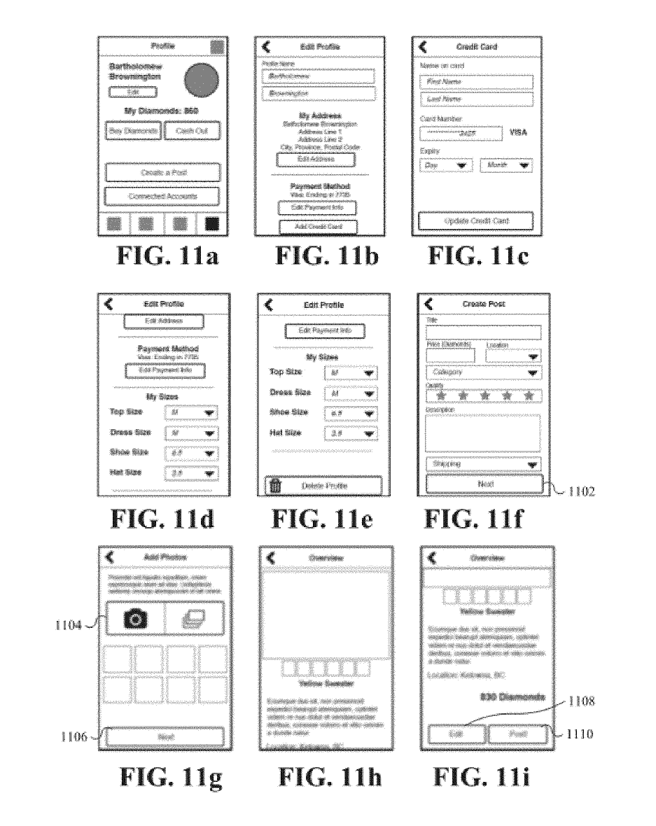

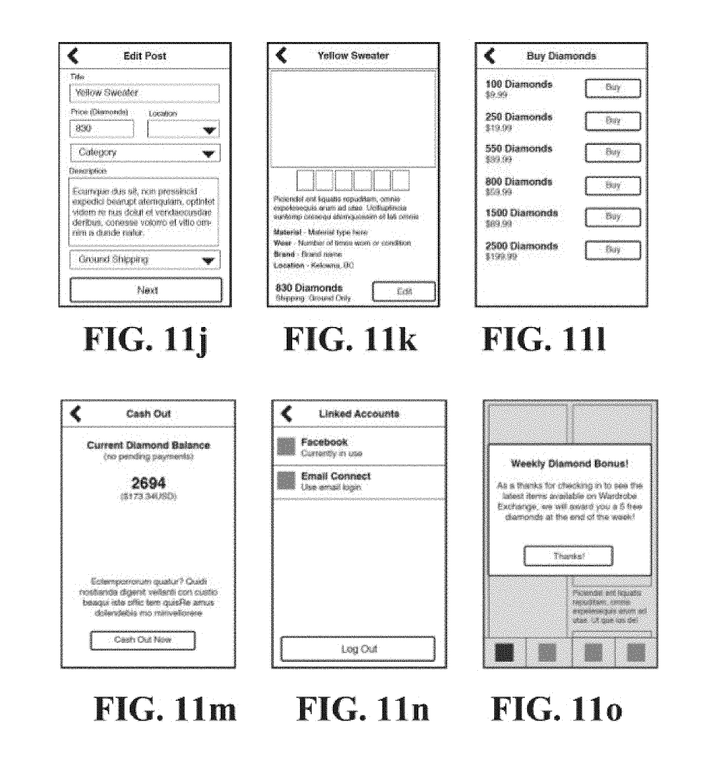

If step 418 is selected by a user (i.e. “D” in FIG. 4), then process 800 illustrated in FIG. 8 is carried out. Device 112 executing app 114 displays a user profile page (step 802). An example of a user profile page is provided at FIG. 11a. App 114 then receives further user input (step 804) such as touch or keyboard input.

If the user input directs that information about an item by posted (step 806), then app 114 is adapted to allow the user to create or compose a post message (step 807). If the post message is to be moderated (step 808) (for example, to ensure compliance with app usage policies), then a moderator will review the candidate post message and edit or delete the post message (step 809) as appropriate prior to the message being posted (step 810) to database 104. The composition of the message to be posted, when involving an item to be offered, may include the pages shown in FIG. 11f to FIG. 11i. Such pages allow a user to input specifications of an item for sale or exchange. Examples of specifications include the price of the item in in-system virtual currency, and location, quality, category, description, shipping, or photographs of the item. Further, as illustrated specifically in FIG. 11g, uploading of a photograph of the item is accomplished using app 114. Such uploading can be accomplished by a method known in the art. For example, FIG. 11f depicts an interface used to create and post a wardrobe item for sale. After basic information such as title, price in in-system virtual currency (e.g. “diamonds”), location, category, or description is specified; a user presses a button 1102 labeled “Next” to advance to the next user interface page depicted in FIG. 11g. The user presses a button 1104 depicting a camera icon, which invokes a camera application programming interface (API), to physical camera 326. As will be appreciated by those skilled in the art, modern operating systems for smartphones and tablets such as iOS™ provide a specialized software module or object that manages customizable, operating-system-supplied user interfaces for taking pictures and movies, and for choosing saved images and movies for use in a custom app such as app 114. Camera 326 provides a captured digital image to app 114. The captured image is then uploaded to server 102 and stored in database 104 associated with the to-be exchanged item. The user may then see the item page that is about to be posted as illustrated in FIG. 11h. As illustrated in FIG. 11i, the use is able to edit the item page further by clicking an edit button 1108 or post the message by clicking a post button 1110. As will be understood by a person of skill in the art, various data structures that digitally represent entities such as wardrobe items, users, diamond accounts, messages, images and the like are maintained at both device 112 and the server 102. The data structures are implemented in one of several programming languages and associated application development frameworks using a programming language independent specification format such as JavaScript Object Notation (JSON) or the Extensible Markup Language (XML). Alternately, programming language dependent data structures can also be used. Data structures can be implemented using well known programming and data interchange constructs such as objects, records, structs, arrays, vectors, hash tables, keyed lists and the like, that are available in most modern programming languages. Simple data structures can be nested together to create complex data structures. Data values contained within data structures are stored in, or retrieved from database 104 at the server 102 or storage medium 310 in device 112, as needed. The message associated with the item is then posted (step 810). The edit page for a posted item is as illustrated in FIG. 11j which is also used to edit the post to adjust one or more of the title, price, description, shipping method or the like.

If the profile of the user is to be edited (step 811) as shown in FIG. 11b, then after checking if deletion is desired (step 812) then the profile may be deleted (step 813) by clicking on a “delete” button (for example, as illustrated in FIG. 11e). However, as may typically be the case, if no deletion is desired then the profile is updated (step 814) and optionally shipping or credit card information for the user is also updated (step 816) as depicted in FIG. 11c. Examples of app pages of app 114 associated with aspects of the above steps are depicted in FIG. 11d which permit the user to edit address or payment information.

If the user wishes to obtain in-system virtual currency (e.g. “diamonds”) (step 818), then a process for purchasing more in-system virtual currency (step 822) is executed. If the user wants to cash out in-system virtual currency (step 820), then a process for cashing out of the in-system virtual currency is executed (step 824). Example pages of app 114 associated with aspects of the above steps are illustrated in FIG. 11l and FIG. 11m.

If step 420 is selected by a user (i.e. “E” in FIG. 4), then process 900 illustrated in FIG. 9 is carried out. Device 112 executing app 114 increments the login count for a defined period such as the daily login count (step 902). App 114 may display a reward message such as that illustrated in FIG. 11o, and receives further user input (step 904). App 114 check may check if a threshold is met (step 906), and reward the user by crediting the user's account with an appropriate amount of diamonds 908.

In operation, a user installs an app, such as app 114, on to his or her device and executes the app.

### General:

It is contemplated that users of the electronic commerce system described herein may engage the app with a high degree of flexibility in terms of participation. The system offers a new type of shopping experience using an in-system virtual currency (e.g. “diamonds”) to acquire or trade for items available on the electronic commerce system. The mobility of devices running apps provides the opportunity to engage in the shopping experience when it is convenient. Moreover, users can set alerts to push items on their wish lists so as not to miss out on items of interest.

Although detailed exemplary embodiments have been discussed in relation to wardrobe exchanges, those of skill in the art will readily understand that the invention is not confined to just wardrobe but may be used to exchange other goods and services.

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

What is claimed is:

1. A method of providing an electronic exchange for a plurality of items, the method comprising, at a server:
maintaining, information corresponding to each of the plurality of items, and an account for each user of the exchange;
receiving a purchase request from a purchaser for a selected one of the plurality of items through an electronic device in communication with the server, the request comprising a purchaser identifier and an item identifier for the selected item;
obtaining, for the selected item, the corresponding information comprising at least an image of the item, a seller of the item, and a price associated with the item, the price denominated in a virtual currency usable only within the electronic exchange;
verifying that an account of the purchaser has an amount at least equal to the price; and
completing a purchase of the selected item by crediting an account of the seller and debiting the account of the purchaser by the price.

2. The method of claim 1, wherein the plurality of items comprises wardrobe items.

3. The method of claim 1, wherein the electronic device is a mobile handheld device.

4. The method of claim 3, wherein the device is a mobile phone running an app.

5. The method of claim 1, wherein the electronic device is a personal computing device running browser software.

6. The method of claim 1, further comprising receiving a request to purchase the virtual currency with real currency.

7. The method of claim 1, wherein further comprising accepting a request to exchange the virtual currency for real currency.

8. A system for exchanging a plurality of items using a virtual currency, the system comprising:
a server comprising a first processor, first memory interconnected with the first processor, an input interface in communication with the first processor, a display in communication with the first processor, a first network interface in communication with the processor, and a first computer readable medium in communication with the processor, the first computer readable medium adapted for storing processor executable instructions that, when executed on the first processor:
maintain information corresponding to each of the plurality of items;
receive a purchase request from a purchaser for a selected one of the plurality of items, the request comprising a purchaser identifier and an item identifier for the selected item;
obtain for the selected item, the corresponding information comprising at least an image of the item, a seller of the item, and a price associated with the item, the price denominated in a virtual currency usable only within the electronic exchange;
verify that the purchaser has an account in the system having an amount at least equal to the price; and
complete a purchase of the selected item by crediting an account of the seller and debiting the account of the purchaser by the amount denominated in the virtual currency; and
an electronic device in communication with the server comprising a second processor, a second memory interconnected with the second processor, a second network interface in communication with the second processor, and a second computer readable medium in communication with the second processor, the second computer readable medium adapted for storing processor executable instructions that, when executed cause the second processor to send the purchase request from for the selected item.

9. The system of claim 8, wherein the plurality of items comprises wardrobe items.

10. The system of claim 8, wherein the device is a mobile phone running an app.

11. The system of claim 8, wherein the electronic device is a personal computing device running browser software.

12. An electronic device comprising a processor, a memory interconnected with the processor, a network interface in communication with the processor, and a computer readable medium in communication with the processor, the computer readable medium adapted for storing processor executable instructions that, when executed cause the processor to send a purchase request from a user for a selected one of the plurality of items, the request comprising a user identifier and an item identifier for the selected item to a server,
wherein the server maintains information corresponding to each of the plurality of items; receives the purchase request; obtains for the selected item, the corresponding information comprising at least an image of the item, a seller of the item, and a price associated with the item, the price denominated in a virtual currency; verifies that the user has an account having an amount at least equal to the price; and completes purchase of the selected item by crediting an account of the seller and debiting the account of the user by the amount denominated in the virtual currency.

13. The electronic device of claim 12, wherein the electronic device comprises a mobile handheld device.

14. The electronic device of claim 13, wherein the device is a mobile phone running an app.

15. The electronic device of claim 12, wherein the device is a personal computing device running browser software.

16. The electronic device of claim 12 further comprising a display in communication with the processor wherein, the device receives from the server, information corresponding to at least some of the plurality of the items prior to sending the purchase request to the server, and displays the received information on the display.

17. The electronic device of claim 16, wherein the display is a touch screen.

18. The electronic device of claim 12 further comprising a user input interface, wherein the device receives user input from the user via the input interface to purchase the selected item.

19. The electronic device of claim 14, wherein the app includes at least one of news, notifications and messages received from the server.

20. The electronic device of claim 14, wherein executing the app causes the processor to increment a login count within a defined period, and upon the count exceeding a threshold, a user of the device is rewarded by the server by crediting the account of the user with a predetermined amount of the virtual currency.
